(19) United States
(12) Patent Application Publication
(10) Pub. No.: US 2013/0284364 A1
(43) Pub. Date: Oct. 31, 2013

(54) Adhesives For Construction Materials Such As Tiles

(71) Applicants: Marysusan Couturier, Framingham, MA (US); Jyoti Seth, Andover, MA (US); Robert A. Wiercinski, Lincoln, MA (US); Hanna Lawicka, Poznan (PL)

(72) Inventors: Marysusan Couturier, Framingham, MA (US); Jyoti Seth, Andover, MA (US); Robert A. Wiercinski, Lincoln, MA (US); Hanna Lawicka, Poznan (PL)

(21) Appl. No.: 13/881,283

(22) PCT Filed: Oct. 21, 2011
(86) PCT No.: PCT/US2011/057193

§ 371 Date: Jul. 16, 2013

Related U.S. Application Data
(60) Provisional application No. 61/406,322, filed on Oct. 25, 2010.

(51) Int. Cl. C09J 7/02

(52) U.S. Cl. CPC C09J 7/0207
USPC 156/307.1; 428/41.8

(57) ABSTRACT

Adhesive composition in mat or sheet form for setting construction materials such as tiles. The adhesive composition comprises at least one pressure sensitive adhesive and a reactive adhesive dispersed therein, wherein said reactive adhesive forms a blend or a semi or fully interpenetrating network or a reinforcing phase throughout said pressure sensitive adhesive, said mat having a thickness defined between a first side and a second side opposite said first side, and at least one release layer removably secured to one of said first side or said second side. Embodiments include application of the adhesive by providing an adhesive mat having a back release liner and a top release liner opposite the back release liner, removing the back release liner, laying the mat on the substrate such as a floor, applying pressure to the mat to ensure good contact between the mat and the substrate, removing the top release liner, and positioning the tile onto the adhesive mat.

### BACKGROUND OF THE INVENTION

Construction materials such as tiles and the like, particularly ceramic tiles, must be affixed to substrates such as walls, ceiling and floors, with an adhesive. More specifically, one conventional method to adhere a tile to a substrate is to apply adhesive to the substrate, place the tile on top of adhesive and wait a given period of time for the adhesive to dry. The oldest form of adhesives still used widely today is based on cement. Cement and sand are mixed with water to a trowelable consistency. The amount of water and the drying rate will affect the physical properties of the mortar. Thin set is a take-off of this where additional materials such as latex are added. U.S. Pat. No. 4,501,617 talks about adding modified hydroxyethyl cellulose thickeners to improve tack and cohesiveness of the mortar. In U.S. Pat. No. 4,402,752, Chesney teaches mortar compositions with improved sag resistance. In U.S. Pat. No. 5,753,036 Hornaman discusses the addition of PVOH stabilized latex mortar formulations with improved performance. However, all of these mortar based products have major drawbacks, such as having to mix water, messy application, need of respirator, time consuming, weight of materials along with time constrains such as having to wait at least 24 hours prior to grouting.

Organic adhesives, more commonly referred to as mastics, are also used to adhere tiles to a substrate. These are typically based on acrylic emulsions, as described in EP 0626397. While mastics generally do not require premixing, they still need to be trowelled onto the substrate and one needs to wait a minimum of 24 hours to grout to allow time for the water to evaporate.

Another way to adhere tiles to a substrate is with a pressure sensitive adhesive. In this application, the adhesive is applied to the substrate in the form of a mat having a release liner. After the adhesive mat is applied to the substrate, the release liner can be removed, exposing the adhesive, and the tiles are placed onto the mat. The tiles may be grouted immediately thereafter, as there is no need to wait for water to evaporate from the adhesive.

Another conventional adhesive used to adhere tiles is a composite membrane that consists of a thermoplastic adhesive with a mesh imbedded in the surface of it. The adhesive is composed of butyl, bitumen or styrenic block copolymer. The disadvantage of this composite membrane is it's limitation in load bearing capacity. Bitumen-based products also suffer from odor and oil bleed. Additionally, these type of thermoplastic adhesives are considered weak and do not meet ANSI specifications, such as 136.1 or 118.2.

Still another approach involves the use of acrylic foam or a layer comprising acrylic foam and a pressure sensitive adhesive to adhere ceramic tiles to a substrate in a membrane form. However, UV crosslinked acrylic adhesives such as these, while having improved load bearing capacity, suffer from poor substrate wetting and low compression modulus. This application is also for temporarily adhering tiles to a wall board, such as in displays, and is not intended for permanent adhesion.

It is also known to use a rigid backing sheet with beads of adhesive in parallel array for adhering tiles to walls. However, the areas of the wall where no adhesive are can have negative drawbacks, such as allowing moisture ingress, which in turn can cause mold or deterioration of the wallboard. The lack of a continuous adhesive will also diminish the overall load bearing capacity of the system and could have problems with larger or heavier tiles.

Adhesives based on butyl adhesive chemistry have limited load bearing capacity and low shear strength. Since butyl based pressure sensitive adhesives are not crosslinked and are manufactured in the hot melt form, they are very susceptible to creep under low loads. Extruded butyl adhesives may have higher modulus, but will still have long term creep problems. For this reason, tile adhesive mats will have severe limitations on tile size and location, i.e., non-floor, ceiling types. Styrenic block copolymers based pressure sensitive adhesives, which are not crosslinked, will suffer the same drawbacks as the butyl pressure sensitive adhesives based on their chemical nature.

The backs of most ceramic tiles are irregular and often contain areas which are depressed. The depressed areas can be as much as 70 mils deep from the raised grid patterns. This uneven surface can make it very difficult for mortars and adhesives to make 100% contact with the back surface of the tile. Areas which are not covered with mortar or adhesive can will be unsupported and are a leading cause of cracked or failed tiles. An adhesive which can change its dimension upon application of the tile would be highly desirable.

It therefore would be desirable to provide a tile adhesive composition which may be applied in mat or sheet form and offers improved adhesive strength over what is commercially available in mat or sheet form. It further would be desirable to provide an adhesive composition that allows for the application of grout on the same day the adhesive is applied.

### SUMMARY OF THE INVENTION

The problems of the prior art have been overcome by the embodiments disclosed herein, which include an adhesive composition in mat or sheet form for setting construction materials such as tiles. In certain embodiments, the adhesive mat can be between about 20 and about 150 mils thick. By mat, we refer to an adhesive layer having uniform two dimensions, thickness and width. The width can vary from 2 to 48 inches. Adhesives having consistency of semi-solid to solid such as ability to maintain their own shape are acceptable to be used as a mat or sheet. Adhesives having consistency of semi-solid to solid such as ability to maintain their own shape are acceptable to be used as a mat or sheet. The term mat as used herein includes an adhesive having a consistency such that it is a solid or semi-solid and can maintain its own shape. A preferred thickness is between 50 and 150 mils not including the release liner. In certain embodiments, the adhesive composition comprises a crosslinkable adhesive, either in the form of a pressure sensitive adhesive (PSA), or a layer of an adhesive capable of crosslinking and a PSA. In certain embodiments, the PSA is only partially crosslinked. In certain embodiments, the adhesive mat comprises at least one pressure sensitive adhesive and a reactive adhesive dispersed therein, wherein said reactive adhesive is capable of forming a crosslinked, semi or fully interpenetrating network or reinforcing phase throughout said pressure sensitive adhesive. Although the extent of crosslinking can be determined by methods known in the art, such as the swelling method, NMR or microscopic techniques, it is not necessary to know the actual cross-linking density. The extent of cross-linking is chosen based upon desired polymer flexibility and rigidity; the higher the cross-linking density, the less flexible and more rigid the polymer becomes. In certain embodiments, the adhesive mat comprises a semi-interpenetrating network where the base polymer is a PSA and the network includes a crosslinked polymer. The application of the adhesive in mat or sheet form with one or more release layers provides numerous advantages over current technology such as thin set mortars or mastics. In their method aspects, embodiments disclosed herein include application of the adhesive by providing an adhesive mat having a back release liner and a top release liner opposite the back release liner, removing the back release liner, laying the mat on the substrate such as a floor, applying pressure to the mat to ensure good contact between the mat and the substrate, such as by lightly rolling with a rolling pin or some other means, removing the top release liner, and positioning the tile onto the adhesive mat. There is no mixing, dust nuisance, heavy bags, or messy clean up associated with cementitious products. Also, as with all mortars and mastics, there is no need to handle liquid or paste-like products which need to be troweled onto the substrate. Further still, since one does not need to wait for the water to evaporate, the application of grout can be carried out shortly after the tile is applied to the substrate, usually on the same day.

The use of a crosslinkable adhesive provides semi-structural to structural strengths and meets the more demanding tile application requirements that are characteristic of flooring, for example. For this application, the adhesive needs to be able to transfer the load to the subfloor and not allow the tile to deflect. Soft adhesives with low compressive strength will deflect and cause the tile to break.

In certain embodiments, the adhesive is supplied in roll form, and cut into suitably size mats for installation of tile to a substrate.

In certain embodiments, the adhesive mat includes a reactive adhesive based on epoxy and/or acrylic and/or urethanes. In certain embodiments, the hot melt pressure sensitive adhesive comprises styrene block copolymer (1-50%) or paraffinic hydrocarbon polymer (1-50%), tackifier (1-60%), plasticizer (0-30%), compatibilizer (0-15%), antioxidants (0-1%), UV stabilizer (0-0.5%), urethane prepolymer (1-80%) and filler (0-70%). In certain embodiments, the pressure sensitive adhesive is based on acrylic, butyl, polyisobutylene, natural rubber, poly-isoprene, chloroprene or combinations thereof.

In certain embodiments, the adhesive mat includes a reactive adhesive based on silane terminated polyurethane resin moisture curing polymers (1-80%) with tin catalyst in the amount of 0.5-1%. The silane terminated polyurethane resin is based on alkoxysilanes reacted with isocyanates and/or urethane prepolymers.

### DETAILED DESCRIPTION OF THE INVENTION

In accordance with certain embodiments, the addition of a crosslinkable adhesive portion to the PSA provides both the benefit of the PSA in terms of ease of application, but also provides semi-structural strength to covalently bond the tile to the adhesive, thus providing greatly improved shear strength and load bearing capacity. In certain embodiments, the crosslinkable adhesive is based on reactive chemistry, with suitable crosslinkable adhesives being based on isocyanates, urethane or urea chemistry, acrylic chemistry, epoxy chemistry, and silane chemistry. A mixture, graft polymer, or hybrid of any of the above moieties also may be used. For example, a reactive adhesive based on polyisocyanate may comprise a prepolymer produced from the reaction of an isocyanate (e.g., MDI, TDI, HDI, etc.) and a polyol such an a polyether or polyester. The reaction of the isocyanate with the polyol is typically carried out with an excess of isocyanate groups such that the prepolymer is isocyanate functional. The crosslinking agent may be in the form of moisture, either via the air, applied to the tile, or the grout. Other crosslinking agents such as amines, ureas, Lewis acids, Lewis bases, polyols, anhydrides or other active hydrogen moieties may be employed. Catalysts such as tin compounds may also be used to accelerate the reaction. In general, increasing the reaction temperature may also be used to either initiate or facilitate the crosslinking. The temperature dependence of crosslinking can be determined by those skilled in the art after determination of the activation energy of crosslinking and curing rate constants. One example may be the use of calcium oxide, which when it comes in contact with water has an exothermic reaction. Heat may also be used to deblock a crosslinking agent. Reactive hot melt adhesives are suitable, and are exemplified in, for example, U.S. Pat. Nos. 3,931,077, 4,808,255, 4,996,283, 5,018,337, 5,342,873, 5,616,625, 6,051,652, 6,280,561, and 7,300,996, the disclosures of which are hereby incorporated by reference. Functionalized graft polymers may also be used. The addition of terpolymer containing an acid or anhydride group can greatly increase the adhesion to a basic substrate such as a ceramic tile.

In certain embodiments, a homogeneous composition that is pressure sensitive in uncured form and comprises a reactive plasticizer, for example, isocyanate-terminated prepolymer from a hydroxyl-terminated polyolefin resin and diphenylmethane diisocyanate, in an amount of 1-30%, or epoxide soy bean oil in an amount of 1-20% can be used. Modulus increases after cross-linking with moisture to yield a structural adhesive. The reactive plasticizer should be compatible with the other pressure sensitive ingredients like tackifier and rubber. One suitable composition is a functional liquid polybutadiene as an additive with appropriate rubber such as styrenic block copolymers (1-50%), tackifier such as aliphatic hydrocarbon resin (1-60%) and compatible plasticizer, for example, naphthenic oil (1-30%).

IPN stability may be enhanced by the addition of a compatibilizer such as a block copolymer (1-20%). Suitable compatibilizers include a polybutadiene resin with terminal hydroxyl groups, a urethane prepolymer or an isocyanate reacted with amine or hydroxyl-terminated polyolefin (1-20%), and a polybutadiene resin with terminal hydroxyl groups. For example, a suitable compatibilizer can be obtained by the reaction of the urethane prepolymer or isocyanate with amine or with hydroxyl-terminated polyolefin (1-20%) with one portion of the block copolymer compatible with one phase (PSA), and the other portion of the block copolymer compatible with the other phase which is the reactive adhesive. In certain embodiments, block copolymer-based compatibilizers can be used, with one block compatible with the pressure sensitive adhesive and the other block compatible with the urethane. For example, a urethane block can comprise a polyester or polyether similar to that used to produce the isocyanate pre-polymer, and the pressure sensitive adhesive compatible block can comprise polybutadiene, polyisoprene, polystyrene, or any other type of compound that is compatible with the pressure sensitive adhesive.

Suitable substrates include wood, plastic, plaster, concrete, gypsum, concrete, etc. In certain embodiments, the substrates are planar or substantially planar. In certain embodiments, the substrates are horizontal or substantially horizontal.

Fillers, thixatropes, and/or rheological agents may be used to achieve mat consistency and ease of release from the liner. Suitable fillers include calcium carbonate, calcium sulfate, kaolin, talc, barites, mica, feldspar, gypsum, wollastonite, glass fiber, flyash, limestone, cement, sand, fumed silica, garamite, perlite, betonites, mineral wool, cellulose fibers, titanium dioxide, aluminum oxide, wood, flour, rice hulls, PET, PP, PE and other plastics, and recycled rubbers such as ground tire rubber. Inorganic fillers can be dried under vacuum prior to addition to the prepolymer to avoid any premature reactions with moisture. Small particle size polyolefins which are hydrophobic can be used. The amount of filler will depend upon the rheology of the prepolymer and amount of thixatrope, if any present. Typical filler amounts will range from 10 to 85% by weight of the total composition. Recycled materials may also be used as fillers. Examples of these include wood flour, rice hulls, PET, PP, PE and other plastics, and recycled rubbers such as ground tire rubber. Calcium oxide and other materials which react with moisture to generate heat may also be employed, additionally speeding the rate of reaction. Typical thixatropes can include fumed silicas, bentonites, and precipitated calcium carbonates and are typically used in the ranges from 0.1 to 10% by weight of the total composition.

Other common additives such as pigments, colorants, rubbers (e.g., ground tire rubber, thermoplastic rubbers such as styrenic block copolymers, and thermoplastic polyurethane (TPU)), toughening agents, impact modifiers, plasticizers, and moisture scavengers may also be added to the composition to modify the final properties of the adhesive. Typical ranges for pigments, colorants, and moisture scavengers are between 0.1 to 5.0% by weight. Preferable ranges for rubbers, tougheners, impact modifiers, and plasticizers are between 1 and 25% by weight. If the formulation contains calcium carbonate as filler, vinegar may also be sprayed onto the mat or tile prior to final application which will increase the available water and carbon dioxide.

In certain embodiments, the mat or sheet includes one or more removable release members. In a preferred embodiment, the mat has a thickness between a first side for contacting the substrate and a second, opposite side for contacting the tile, and both the first and second sides include a release member. The term mat includes an adhesive supplied in a roll form having a consistency such that it is a solid or semi-solid which can maintain its own shape. Preferred thickness is between 50 and 150 mils without the release liner.

The release member removably affixed to the first side is removed just prior to applying the mat to the substrate. Similarly, the release member removably affixed to the second side is removed just prior to positioning the tile on the mat. Preferably the release members, when removed such as by peeling to expose the adhesive, remove cleanly from the mat and take with them little or no adhesive composition. Suitable release liners include siliconized paper and siliconized high density polyethylene film and PET film and are commercially available from suppliers such as Huhtamaki and Tekkote.

In certain embodiments, a reinforcing agent may be added. Suitable reinforcing agents include fibers, mesh, scrims, woven materials and non-woven materials. Knitted, weaved or laid scrim reinforcing fabrics are acceptable. Fabrics based on PET, nylon, acrylic, fiberglass, aramids, rayon, polyolefins and hybrids of the above are acceptable. Mesh openings can vary from 1 to 50 yarns per inch. The fabric can be coated to improve mechanical, anti-microbial, water and chemical resistance. Examples of suitable coatings include polyvinyl alcohol, PVC, acrylic, and SBR. Saint-Gobain GCD99 is an example of a suitable mesh.

Fibers based on polyethylene, polypropylene, acrylic, polyesters and nylon may also be used to reinforce the adhesive. Suitable examples are low melt-LLDPE fibers form MiniFibers Inc.

In certain embodiments, moisture curing is carried out by applying water to the substrate, to the surface of the adhesive mat, or to both the substrate and the surface of the adhesive mat.

### EXAMPLE 1

A number of different adhesive types were tested for their performance as a tile adhesive under test methods commonly used by the tile industry. The adhesive types are described as follows:

Butyl: A 40 mil thick hot melt butyl based psa adhesive comprising an embedded mesh, commercially available as Bondera.

Bitumen: A bitumen based PSA, commercially available as Denso quick tile adhesive.

Acrylic 1: An UV crosslinked solid adhesive from Adco under the name of ABP 1040.

Acrylic 2. An UV crosslinked solid adhesive from 3M under the name of VHB.

RX-1: A commercially available hexamethylene diisocyanate based polyisocyanate adduct.

The tiles used for all testing were 4×4″ glazed ceramic white tiles which were purchased at a well known home improvement store. The tiles were a standard stocked item. The substrate was standard gypsum backer board.

The adhesives were tested for shear strength based on ANSI A118.12. The pieces of adhesive mats, equal to the size of the bottom of the ceramic tiles, were applied to the backer boards and then the tiles were placed on top of the adhesives. Finally the tiles were pressed by hand, in order to push the tiles in to the adhesive mat. Samples were tested after a 24 hour period. Results are as follows:

| Adhesive type | Shear force, lbs. |
|---|---|
| Butyl | 40 |
| Bitumen | 121 |
| Acrylic 1 | 90 |
| Acrylic 2 | 68 |
| Rx-1, dry tile | >500 tile broke |
| Rx-1, wet tile | >500, tile broke |
| Composite of rx-1 and butyl | 102 |

The minimum shear force required to meet ANSI 118.12 specifications for an organic adhesive for tiles application is 425 lbs. As shown in the above Table, the butyl PSA has the lowest strength. The solid crosslinked adhesives (Acrylic 1 and Acrylic 2) have only slightly improved strength due to their poor surface wetability. The bitumen PSA has shear strength similar to the foamed acrylic. The use of a moisture curing isocyanate (RX-1) shows a dramatic improvement over all other technology in shear strength, where the tile broke before the adhesive bond broke. Either a dry or wet tile had improved strength. A combination of reactive isocyanate and butyl PSA showed improved strength over the butyl alone, however, significantly less than the moisture curing technology alone.

### EXAMPLE 2

Another standard industry tile test is the point load test, ANSI 118.12, as used by the Tile Council of North America. For an adhesive to be used for a floor tile application, it should withstand 1000 lbs force without the tile breaking.

| Adhesive type | Point Load force. Lbs. |
|---|---|
| Butyl | 141 |
| Bitumen | 180 |
| Acrylic 1 | 155 |
| Acrylic 2 | 199 |
| Rx-1, dry tile | >1000 |
| Rx-1, dry tile | >1000 |
| Composite, rx-1 and butyl | 218 |

All of the PSA-based adhesives had strength values less than 200 pounds of force, regardless of the chemistry. These types of adhesives have compressive strengths that are too low, causing the tile to crack. The reactive isocyanate adhesive had forces which exceeded the load cell capabilities.

### EXAMPLE 3

In the adhesive mat containing a semi-inter penetrating network, where the base polymer is a PSA and the network consists of crosslinked polymer, moisture cured urethane prepolymers have been used, such as: diphenylmethane diisocyanate (MDI) prepolymer, toluene diisocyanate (TDI) prepolymer and aliphatic polyisocyanate based on hexamethylene diisocyanate (HDI).

In order to select the most appropriate reactive prepolymers, the chemical structure (shape of the polymer molecule as well as type of the functional groups) and composition of the raw materials were taken into account. The priority was to find prepolymers capable of crosslinking in one-component systems. Therefore, moisture cured urethane prepolymers were focused on. However, free monomer content in the prepolymer product was also very important. For urethane prepolymers the amount of free isocyanate could not exceed 0.1% for TDI and MDI based and for 0.5% for HDI based. Resistance of the urethane prepolymer to decomposition at high temperature (higher than 165° C.) was also important. The functionality, hardness, modulus and elongation of the pure urethane prepolymer were also considered. After screening of urethanes for further application in a hot melt systems using point load test the following urethanes with the low content of free monomers were selected. The amount of free monomers can not be higher than 0.01% in the urethane prepolymers. The urethane prepolymers may be based on MDI-polyether, MDI-polypropylene ether glycol, TDI-polyether, TDI-polypropylene glycol, HDI-polyether, HDI-polycarbonate and HDI-polycaprolactone.

Adhesive mats containing PSA and urethane prepolymers were obtained by a hot melt process. In the first step, a PSA based on styrenic block copolymers, such as SIS (styrene-isoprene-styrene) or SBS (styrene-butadiene-styrene), or other elastomers such as polyisobutylene or polyisoprene was made. For example, PSA includes: tackifier (20-60%), plasticizer (0-30%), styrene block copolymer (5-50%), antioxidants (1%), and UV stabilizer (0.5%). The components were mixed at 140-180° C. temperature until the system became homogeneous. PSA formulations based on these block copolymers are numerous and well known to those skilled in the art, see “Handbook of Pressure Sensitive Adhesive Technology” Donatas Satas Satas & Associates, 1999, chapters 8 and 13. PSA'a based on butyl, acrylic, natural rubber, olefinic polymers and other polymers would also be effective. In this example, the formula consisted of a blend of SIS, hydrocarbon resin and naphthenic oil, along with UV stabilizers (0.5%) and antioxidants (1%). The composition was mixed at 140-155° C. under nitrogen until it was homogeneous.

Selected urethane prepolymers, for example, based on MDI-polyether, MDI-polypropylene ether glycol, TDI-polyether, TDI-polypropylene glycol, HDI-polyether, HDI-polycarbonate or HDI-polycaprolactone, were added to the PSA hot melt. After temperature stabilization (between 140-160° C.) the selected filler was added in the amounts shown in the Table below. The following raw materials were used as fillers:
Kaolin
Talc
Lime Stone
Cement 42,5 R
Fumed silica
Mica
Wollastonite
Glass fibers
Titanium dioxide
Barite
Garamite 1958

Other fillers, inorganic or organic would also be effective, such as those disclosed in “Particulate fillers for polymers” R. N. Rothon, iSmithers Rapra Publishing, 2001.

The homogeneous hot melt adhesive was then applied (coated) onto the release liner. Prepared adhesive mat was then applied on concrete blocks after removing the release liner from one side of the mat. Then the release liner from the other side of the mat was removed and the mat was covered by ceramic tiles. The system is fully crosslinked after 1 to 14 days (depending on the system) at 70% of humidity and temperature 22° C.

In order to enhance the consistency of the systems, a mesh, e.g. made of polyethylene or glass or mineral fibers can be used. In the following examples a polyethylene or glass fiber mesh was used as a reinforcement.

The thicknesses of the adhesive mats were 50-120 mils. The tiles used for the Point Load Test were 6″×6″ and for the Shear test were 4.5″×4.5″.

| | Point Load | Point Load | Shear |
|---|---|---|---|
| | force, lbs | force, lbs | force, |
| Adhesive type | (first source) | (second source) | lbs |
| Styrenic block copolymer PSA (60%), HDI- | 287 | | |
| polyether urethane prepolymer (40%) | | | |
| Styrenic block copolymer PSA (17%), HDI- | 921 | | |
| polyether urethane prepolymer (39%), | | | |
| kaolin (44%) | | | |
| Styrenic block copolymer PSA (18.3%), | 1050 | 1210 | |
| HDI-polyether urethane prepolymer | | | |
| (41.9%), fumed silica - (1.4%), talc (37%), | | | |
| titanium dioxide (1.4%) | | | |
| Styrenic block copolymer PSA (16%), HDI- | 1040 | 1120 | |
| polyether urethane prepolymer (38.6%), | | | |
| talc (45.4%) | | | |
| Styrenic block copolymer PSA (10%), HDI- | 1010 | | |
| polyether urethane prepolymer (23%), lime | | | |
| stone (67%) | | | |
| Styrenic block copolymer PSA (17.2%), | 1170 | | |
| HDI-polyether urethane prepolymer | | | |
| (37.8%), talc - (45%), | | | |
| Styrenic block copolymer PSA (17.2%), | 1000 | | |
| HDI-polyether urethane prepolymer | | | |
| (39.5%), talc (43.3%), | | | |
| Styrenic block copolymer PSA (28.3%), | 871 | 1098 | |
| HDI-polyether urethane prepolymer (65%), | | | |
| fumed silica (6.7%), | | | |
| Styrenic block copolymer PSA (16.9%), | 988 | | |
| TDI-polyether base (40.5%), talc (42.6%), | | | |
| Styrenic block copolymer PSA (18.2%), | 974 | | |
| TDI-polyether base (43.5%), kaolin | | | |
| (38.3%) | | | |
| Styrenic block copolymer PSA (18.6%), | 970 | 1164 | 1270 |
| TDI-polyether base (43.8%), kaolin | | | |
| (37.6%), | | | |
| Styrenic block copolymer PSA (11%), TDI- | 1002 | 1230 | 1220 |
| polyether base (25.5%), Fumed silica (1%), | | | |
| Barium Sulfate (62.5%), | | | |
| Polyisobutylene based PSA (20%), HDI- | 835 | | |
| polyether urethane prepolymer (40%), | | | |
| kaolin (40%) | | | |
| Polyisoprene based PSA (10.7%), HDI- | 1860 | | >2250 |
| polyether urethane prepolymer (43%), | | | |
| polybutadiene with terminal hydroxyl | | | |
| groups (2%), kaolin (43%), fumed silica | | | |
| (1.3%) | | | |
| Styrenic block copolymer PSA (16.2%), | 1040 | | >2250 |
| MDI-polyether (40.8%), polybutadiene with | | | |
| terminal hydroxyl groups (1%), fumed | | | |
| silica (1%), titanium oxide (1%), calcium | | | |
| oxide (1%), talc (39%) | | | |

The above formulations comprise a reactive isocyanate prepolymer dispersed in a pressure sensitive adhesive. Upon exposure to moisture, such as humidity in the air, the isocyanate crosslinks and forms a semi-interpenetrating network through out the pressure sensitive adhesive. Obtained hot melts are formed as an effective adhesive mat for tile applications. The adhesive mats are flexible and flow enough to fill in the gaps in the substrate. However, after crosslinking they are hard enough to meet the requirements of the ANSI standards.

What is claimed is:

1. An adhesive mat comprising at least one pressure sensitive adhesive and a reactive adhesive dispersed therein, wherein said reactive adhesive forms a blend or a semi or fully interpenetrating network or a reinforcing phase throughout said pressure sensitive adhesive, said mat having a thickness defined between a first side and a second side opposite said first side, and at least one release layer removably secured to one of said first side or said second side.

2. The adhesive mat of claim 1, wherein the reactive adhesive crosslinks upon exposure to moisture form the air, or substrate or adherend.

3. The adhesive mat of claim 1, wherein said pressure sensitive adhesive comprises a styrenic block copolymer.

4. The adhesive mat of claim 2, wherein said styrenic block copolymer is selected from the group consisting of styrene-isoprene-styrene, styrene-butadiene-styrene, styrene-ethylene-butylene-stryrene, polyisoprene, styrene-butadiene and combinations thereof.

5. The adhesive mat of claim 1, further comprising a tackifier.

6. The adhesive mat of claim 1, further comprising a plasticizer.

7. The adhesive mat of claim 1, further comprising a compatibilizer selected from the group consisting of a polybutadiene resin with terminal hydroxyl groups, a urethane prepolymer or an isocyanate reacted with amine, and a polybutadiene resin with terminal hydroxyl groups., a polyester, a polyether, polybutadienes, polyisoprene, and polystyrene.

8. The adhesive mat of claim 1, wherein said pressure sensitive adhesive is based on acrylic, butyl, polyisobutylene, natural rubber, poly-isoprene, chloroprene or combinations thereof.

9. The adhesive mat of claim 1, further comprising a filler selected from the group consisting of kaolin, talc, lime stone, cement, fumed silica, mica, wollastonite, glass fibers, titanium dioxide, barite, calcium oxide, garamite, perlite, bentonites, mineral wool, cellulose fibers, calcium sulfate, wood, flour, rice hulls, PET, PP, PE, and recycled rubbers.

10. The adhesive mat of claim 1, further comprising a reinforcing agent selected from the group consisting of fibers, mesh, scrims, wovens and non-wovens.

11. The adhesive mat of claim 1, in which the reactive adhesive comprises a polyisocyanate.

12. The adhesive mat of claim 1, wherein said reactive adhesive is comprises a polyisocyanate selected from the group consisting of MDI-polyether, MDI-polypropylene ether glycol, TDI-polyether, TDI-polypropylene glycol, HDI-polyether, HDI-polycarbonate, HDI-polycaprolactone, MDI-polyester, TDI-polyester and HDI-polyester.

13. The adhesive mat of claim 1, wherein the reactive adhesive comprises a member selected from the group consisting of epoxy, acrylic, urethanes and combinations thereof.

14. The adhesive mat of claim 1, wherein said reactive adhesive is based on silane terminated polyurethane resin moisture curing polymers with tin catalyst.

15. The adhesive mat of claim 11, wherein the silane terminated polyurethane resin is based on alkoxysilanes reacted with isocyanates and/or urethane prepolymers.

16. A method of affixing a tile to a substrate, comprising providing an adhesive mat comprising at least one pressure sensitive adhesive and a reactive adhesive dispersed therein, wherein said reactive adhesive is capable of forming a crosslinked, semi-interpenetrating network or reinforcing phase throughout said pressure sensitive adhesive, said mat having a thickness defined between a first side and a second side opposite said first side, applying said mat to said substrate by contacting said first side with said substrate and applying pressure to said mat; positioning said tile on said second side and applying pressure to said tile; and allowing said adhesive to cure.
